(19) United States
(12) Patent Application Publication
(10) Pub. No.: US 2006/0204613 A1
(43) Pub. Date: Sep. 14, 2006

(54) Chewing gum containing flavor delivery systems

(76) Inventors: Armando J. Castro, Westchester, IL (US); David L. Witkewitz, Bridgeview, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 11/355,263

(22) Filed: Feb. 15, 2006

Related U.S. Application Data
(60) Provisional application No. 60/654,564, filed on Feb. 18, 2005.

(51) Int. Cl. A23G 4/00

(52) U.S. Cl. 426/3

(57) ABSTRACT

A method of producing a chewing gum product includes providing a core including a first flavoring agent. The core is coated with a first layer to form a first coated product. The first layer may be a hydrophobic layer or a hydrophilic layer. The first coated product is coated with a second layer including a second flavoring agent to form an encapsulated particle. The second layer may be a hydrophobic layer or a hydrophilic layer. A plurality of the encapsulated particles is mixed with gum base to form a chewing gum composition. The chewing gum composition is formed into a chewing gum product.

### RELATED APPLICATIONS

This application claims the benefit of U.S. Provisional Patent Application No. 60/654,564, filed Feb. 18, 2005, the entire disclosure of which is hereby incorporated herein by reference.

### BACKGROUND

Chewing gums typically provide a sustained release of flavor. However, in some cases it may be desirable to provide an initial burst of flavor, followed by second burst of a same or different flavor. Additionally, after sustained chewing, a substantial portion of flavor remains in the gum base but is not easily released from the gum base. Therefore, it would be desirable to have some mechanism to help release the trapped flavor in the gum base. Thus, it would be desirable to have a flavor delivery system that provides a delayed release of a flavor or multiple flavors.

### BRIEF SUMMARY

It has been found that by encapsulating a flavoring agent, a chewing gum can be formed that provides a delayed release of the flavoring agent when the chewing gun is chewed by a consumer.

In one aspect, a method of producing a chewing gum product includes providing a core including a first flavoring agent. The core is coated with a first layer to form a first coated product. The first layer may be a hydrophobic layer or a hydrophilic layer. The first coated product is coated with a second layer including a second flavoring agent to form an encapsulated particle. The second layer may be a hydrophobic layer or a hydrophilic layer. A plurality of the encapsulated particles is mixed with gum base to form a chewing gum composition. The chewing gum composition is formed into a chewing gum product.

In another aspect, a chewing gum product includes a plurality of encapsulated particles. The encapsulated particles include a core including a first flavoring agent. A first layer surrounds the core and includes a hydrophobic material. A second layer surrounds the first layer and includes a second flavoring agent and a hydrophilic material. The chewing gum provides a first wave of flavor from the second flavoring agent followed by a second wave of flavor from the first flavoring agent.

The foregoing and other features and advantages of the present invention will become apparent from the following detailed description of the presently preferred embodiments, when read in conjunction with the accompanying examples.

### DETAILED DESCRIPTION OF THE DRAWINGS AND PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In one aspect, the present invention is directed to chewing gums with flavor delivery systems. In particular, it provides chewing gums with multiple flavor waves and methods of making them. By multiple flavor waves is meant that the chewing gum provides an initial flavor sensation, which reaches a peak and tapers off, followed by a second flavor sensation. A third or even further flavor waves may follow. The flavor waves may be the same flavor or different flavors. The flavor waves may include not only flavors, but sweeteners, cooling agents, sensates, and the like. The second flavor wave preferably occurs after about 1 to 8 minutes of chewing, most preferably after about 3 minutes of chewing.

In one embodiment, the chewing gum includes an encapsulated flavoring agent. The encapsulated flavoring agent includes a plurality of encapsulated particles. Each encapsulated particle includes a core with a first flavoring agent, a first layer surrounding the core, and a second layer surrounding the first layer and including a second flavoring agent. In other embodiment, further layers may be applied, with or without additional flavoring agents.

In another embodiment, the chewing gum includes a plurality of two types of encapsulated particles. The first type of encapsulated particle includes a first flavoring agent and a first coating. The second type of encapsulated particle includes a second flavoring agent and a second coating. The second coating may be either thicker than the first coating, or of a different material, so that the first flavoring agent is released first as the gum is chewed, followed afterwards by the second flavoring agent.

The term “flavoring agent” is meant to include flavors, sweeteners, cooling agents, sensates, and the like. The flavors used in the various layers of the confectionary product may include cooling agents such as menthol as well as essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in the confectionary product. Those skilled in the art will recognize that natural and artificial flavoring agents may be combined in any sensorially acceptable blend. All such flavors and flavor blends are contemplated by the present invention.

Physiological cooling agents may also be used. A variety of physiological cooling agents are discussed in U.S. Pat. No. 6,627,233, the contents of which are hereby incorporated by reference herein. Preferred physiological cooling agents are substituted p-menthane carboxamides (such as WS-3); acyclic carboxamides (such as WS-23); menthone glycerol ketal; menthyl lactate; menthyl succinate; and 3-l-menthoxypropane-1,2-diol.

Sensates may also be used as flavoring agents and include cooling agents, and pungent, hot, and tingling flavors.

In one embodiment, the encapsulated particle includes a core with a first flavoring agent. The core is surrounded by a first layer. The first layer preferably includes a hydrophobic material. The first layer allows the first flavoring agent to have a delayed introduction into the user's senses. The first layer is coated with a second layer including a second flavoring agent. The second layer is preferably hydrophilic and provides an immediate flavor sensation in the mouth of a user. Although a preferred embodiment includes a first hydrophobic layer and a second hydrophilic layer, greater numbers of layers are possible.

It will be apparent that more than one flavoring agent may be used in the various layers of the encapsulated particle. In particular, a flavor or physiological cooling agent is preferably combined with a sweetener.

The flavoring core may be prepared by any suitable method. In one embodiment, the core is between about 10 microns and about 100 microns in diameter. In another embodiment, the core is between about 0.2 microns and about 10 microns in diameter. When multiple coatings are required, it is desirable to have as small of a flavoring core as possible. Small particles allow a fluid bed coater to coat multiple layers upon the flavoring core. In one embodiment, the encapsulated particle includes up to 6 layers of coating.

The first layer is preferably made from a hydrophobic or low water-solubility material. Such hydrophobic or low water-solubility compositions include acrylic polymers and copolymers, carboxyvinyl polymer, polyamides, polystyrene, polyvinyl acetate, polyvinyl acetate phthalate, polyvinylpyrrolidone and waxes. Two food-grade coating materials that are good film formers but not water soluble are shellac and zein. The material is preferably selected from zein, wax, and polyvinyl acetate. The hydrophobic material preferably imparts elasticity to the encapsulated particle so that it can withstand mastication for a sufficient period of time to provide a second flavor wave.

Zein is normally thought to be relatively insoluble in water, except at high pH. However, it has been found that by reducing the zein particle size to less than about 150 micron, the solubility increases dramatically. This reduced particle size allows a high concentration aqueous solution to be prepared which has greater film formation properties during encapsulation. The film coats aspartame, other high intensity sweeteners, or other flavoring agents to reduce their water solubility. The encapsulation extends the sweetener and flavor duration in the chewing gum. Zein can be milled to the smaller particle size with a Fitzmill Comminutor.

In one embodiment, the second layer includes a hydrophilic or water soluble material. Materials which are water soluble include agar, alginates, a wide range of cellulose derivatives like ethyl cellulose, methyl cellulose, sodium hydroxymethyl cellulose, and hydroxypropylmethyl cellulose, dextrin, gelatin, and modified starches. Other encapsulants like acacia or maltodextrin can also encapsulate a flavoring agent and give a fast release rate of a flavoring agent in gum. Preferred materials include acacia gum, gelatin, maltodextrin, and shellac.

The amount of coating or encapsulating material on the flavored core controls the length of time for its release from chewing gum. Generally, the higher the level of coating and the lower the amount of active a flavoring agent, the slower the release during mastication. To obtain the delayed release of the flavoring agent in the core, the first layer should be a minimum of about 20% (by weight) of the core. Preferably, the first should be a minimum of about 30% (by weight) of the coated flavoring agent. Depending on the coating material, a higher or lower amount of coating material may be needed to give the desired release.

The core may be prepared by any suitable method. These techniques include, but are not limited to, spray drying, spray chilling, and coacervation. These techniques may be used individually in a single step process or in any combination in a multiple step process.

In spray drying, the core is prepared by spraying a composition including a flavoring agent and a carrier such as an acacia gum (such as gum arabic or gum talha), maltodextrin, or gelatin. In one embodiment, it may be prepared by the spray drying technique discloses in U.S. Published Application 2004/0022895, the contents of which are hereby incorporated by reference herein.

The mixture used for the spray drying will generally comprise about 0% to about 60% water, about 32% to about 10% carrier ingredients and about 5% to about 12% flavor prior to being spray dried. To prepare flavors for spray drying, the carrier is hydrated to give a 40-50% solution. In one embodiment, the flavor is added to a mix of acacia gum and homogenized. The ratio of solids to flavor material is preferably about 4:1. The flavor/carrier mixture is fed into a Niro Atomizer Spray Dryer, where it is atomized through a spinning wheel. Hot air flowing in co-current direction contacts the atomized particles and evaporates the water. This produces dried particles having a matrix containing small droplets of flavor to be used as the core material.

The core may also be solid flavor, such as a solid crystal sweetener or physiological cooling agent. In another embodiment, a flavoring agent may be absorbed onto another component which is porous and become entrapped in the matrix of the porous component. Common materials used for absorbing a flavoring agent include, but are not limited to, silicas, silicates, cellulose, pharmasorb clay, spongelike beads or microbeads, amorphous carbonates and hydroxides, including aluminum and calcium lakes. Cyclodextrin is another material than be used to fix a liquid flavor.

Depending on the type of absorbent materials and how it is prepared, the amount of flavoring agent that can be loaded onto the absorbent will vary. Generally materials like polymers or spongelike beads or microbeads, amorphous sugars and alditols and amorphous carbonates and hydroxides absorb about 10% to about 40% of the weight of the absorbent. Other materials like silicas and pharmasorb clays may be able to absorb about 20% to about 80% of the weight of the absorbent.

The general procedure for absorbing a flavoring agent onto the absorbent is as follows. An absorbent like fumed silica powder can be mixed in a powder blender and an aqueous solution of a flavoring agent can be sprayed onto the powder as mixing continues. The aqueous solution can be about 1 to 2% solids, and higher solid levels to 15-30% may be used if temperatures up to 90° are used. Generally water is the solvent, but other solvents like alcohol could also be used if approved for use in food. As the powder mixes, the liquid is sprayed onto the powder. Spraying is stopped before the mix becomes damp. The still free-flowing powder is removed from the mixer and dried to remove the water or other solvent, and is then ground to a specific particle size.

The core is preferably coated using fluid bed technology. In a fluid bed coater, the solid core particles are suspended in a stream of air. A liquid is sprayed into the fluidized particles, coating the particles. Coating levels range from 5% to 50% (by weight), depending on the substrate's particle size and the degree of coating desired. In the present invention, a bottom spray or Wurster coater is preferably used. This type of coater is known in the art. The Wurster coater includes a generally cylindrical coating chamber surrounding a separate cylinder in the core, known as a partition. A nozzle is partitioned in the core of a plate under the partition to spray a liquid upwardly through the partition. Air flow is directed through the partition, transporting the substrate past the nozzle which sprays concurrently into the fluidized material. The fluid bed coater may be used to provide both the first layer and/or the second layer of the encapsulated particle.

A method of producing a chewing gum product includes providing a core comprising a first flavoring agent. The core is coated with a first layer, preferably in a fluid bed coater. The first layer may be a hydrophobic layer or a hydrophilic layer. The first layer is preferably about 20% to about 50% by weight of the substrate, most preferably about 30% by weight. The first layer is then coated with a second layer comprising a second flavoring agent. The second layer may be a hydrophobic layer or a hydrophilic layer. The second layer is preferably about 20% to about 50% by weight of the substrate, most preferably about 30% by weight. The two layer coated core forms an encapsulated particle.

In one embodiment, the encapsulated particle is between about 100 microns and about 300 microns in diameter. The encapsulated particles contain about 10% to about 50% available flavoring agent by weight.

The encapsulated particle may then be mixed with gum base to form a chewing gum composition. The level of encapsulated particles in the chewing gum should be between about 1% and about 10%, preferably between about 2% and about 5% by weight. In some cases, no liquid flavor is added to the chewing gum, but various encapsulated particles are used to give a first wave of flavor, and various other encapsulated particles are added to give a second wave of flavor. The chewing gum composition is then formed into a chewing gum product.

In another aspect of the invention, a chewing gum may include an encapsulated material to promote longer release of flavor in the chewing gum, compared to conventional chewing gums. Even after extended chewing, most conventional chewing gums still contain a substantial portion of their original flavor. For example, in one eucalyptol flavored chewing gum, 61% of the flavor remained in the gum after 30 minutes of chewing and 50% remained after 60 minutes of chewing. It is believed that the flavors become bound in the chew base and are difficult to release by further chewing.

To promote longer release of flavor in the chewing gum, a variety of materials may be encapsulated and provided in the chewing gum so that after a period of time, they are released and promote the release of flavor form the chew cud. A mixture of citric acid and/or sodium citrate may be encapsulated with a hydrophobic layer by fluid bed coating techniques. After a suitable period of chewing time, the citric acid and/or sodium citrate is released. This increases the ionic strength of the gum cud and attracts more water into the base to release the flavor.

Phosphate blends may also be encapsulated and added to chewing gum to increase ionic strength in order to release actives such as flavor, sweeteners, cooling agents etc., bound in the gum cud and produce a new wave of flavor or to produce long lasting release. Phosphates are polar substance and have emulsifying capacity. A blend of phosphates with neutral or slightly acid pH makes the gum better tasting. Phosphates increase the ionic strength bringing more water to the gum cud. Salts, such as sodium chloride, and hydrocolloids could also be encapsulated and added to the chewing gum to increase ionic strength in order to release actives such as flavor, sweeteners, cooling agents etc., bound in the gum cud and produce a new wave of flavor or to produce long lasting release.

In general, a chewing gum composition typically comprises a water-soluble bulk portion, a water-insoluble chewable gum base portion and typically water-insoluble flavoring agents. The water-soluble portion dissipates with a portion of the flavoring agent over a period of time during chewing. The gum base portion is retained in the mouth throughout the chew. In one embodiment, the gum base does not contain any flavoring apart from the flavoring agent in the encapsulated particles.

The insoluble gum base generally comprises elastomers, resins, fats and oils, waxes, softeners and inorganic fillers. Elastomers may include polyisobutylene, isobutylene-isoprene copolymer and styrene butadiene rubber, as well as natural latexes such as chicle. Resins include polyvinylacetate and terpene resins. Fats and oils may also be included in the gum base, including tallow, hydrogenated and partially hydrogenated vegetable oils, and cocoa butter. Commonly employed waxes include paraffin, microcrystalline and natural waxes such as beeswax and carnauba. According to the preferred embodiment of the present invention, the insoluble gum base constitutes between about 5% and about 95% by weight of the gum. More preferably the insoluble gum base comprises between about 10% and about 50% by weight of the gum, and most preferably between about 20% and about 35% by weight of the gum.

The gum base typically also includes a filler component. The filler component may be calcium carbonate, magnesium carbonate, talc, dicalcium phosphate or the like. The filler may constitute between about 5% and about 60% by weight of the gum base. Preferably, the filler comprises about 5% to about 50% by weight of the gum base.

Gum bases typically also contain softeners, including glycerol monostearate and glycerol triacetate. Further, gum bases may also contain optional ingredients such as antioxidants, colors, and emulsifiers. The present invention contemplates employing any commercially acceptable gum base.

The water-soluble portion of the chewing gum may further comprise softeners, sweeteners, flavoring agents and combinations thereof. Softeners are added to the chewing gum in order to optimize the chewability and mouth feel of the gum. Softeners, also known in the art as plasticizers or plasticizing agents, generally constitute between about 0.5% and about 15% by weight of the chewing gum. Softeners contemplated by the present invention include glycerin, lecithin and combinations thereof. Further, aqueous sweetener solutions such as those containing sorbitol, hydrogenated starch hydrolyzates, corn syrup and combinations thereof may be used as softeners and binding agents in gum.

As mentioned above, the coated flavoring agent of the present invention may be used in sugar or sugarless gum formulations. Sugar sweeteners generally include saccharide-containing components commonly known in the chewing gum art which comprise, but are not limited to, sucrose, dextrose, maltose, dextrin, dried invert sugar, fructose, levulose, galactose, corn syrup solids and the like, alone or in any combination. Sugarless sweeteners include components with sweetening characteristics but which are devoid of the commonly known sugars and comprise, but are not limited to, sugar alcohols such as sorbitol, mannitol, xylitol, hydrogenated starch hydrolyzates, maltitol and the like, alone or in any combination.

Depending on the particular flavoring agent release profile and shelf-stability needed, the coated flavoring agent of the present invention can also be used in combination with uncoated high-potency sweeteners or with high-potency sweeteners coated with other materials and by other techniques.

A flavoring agent may also be present in the chewing gum in an amount within the range of from about 0.1% to about 10%, preferably from about 0.5% to about 3%, by weight of the gum. The flavoring agents may comprise essential oils, synthetic flavors, or mixtures thereof including, but not limited to oils derived from plants and fruits such as citrus oils, fruit essences, peppermint oil, spearmint oil, clove oil, oil of wintergreen, anise, and the like. Artificial flavoring components are also contemplated for use in gums of the present invention. Those skilled in the art will recognize that natural and artificial flavoring agents may be combined in any sensorally acceptable blend. All such flavors and flavor blends are contemplated by the present invention.

Sugar bulk sweeteners include, but are not limited to, sucrose, dextrose, maltose, dextrin, dried invert sugar, fructose, levulose, galactose, corn syrup solids, and the like, alone or in combination.

Sugarless sweeteners include, but are not limited to, sugar alcohols such as sorbitol, mannitol, xylitol, hydrogenated starch hydrolysates, maltitol, and the like, alone or in combination.

High intensity artificial sweeteners include, but are not limited to, sucralose, aspartame, salts of acesulfame, alitame, saccharin and its salts, cyclamic acid and its salts, glycyrrhizin, dihydrochalcones, thaumatin, monellin, and the like, alone or in combination.

Optional ingredients such as colors, emulsifiers and pharmaceutical agents may be added to the chewing gum.

In general, chewing gum is manufactured by sequentially adding the various chewing gum ingredients to a commercially available mixer known in the art. After the ingredients have been thoroughly mixed, the gum mass is discharged from the mixer and shaped into the desired form such as by rolling into sheets and cutting into sticks, extruding into chunks or casting into pellets. A pellet center may be coated with a hard shell coating that may also contain flavoring agents to give a fast release of flavor initially.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent. Further portions of the bulking agent may then be added to the mixer. A flavoring agent is typically added with the final portion of the bulking agent. The coated flavoring agent of the present invention is preferably added after the final portion of bulking agent and flavor have been added.

The entire mixing procedure typically takes from five to fifteen minutes, but longer mixing times may sometimes be required. Those skilled in the art will recognize that many variations of the above described procedure may be followed.

### EXAMPLES

The following examples of the invention and comparative examples are provided by way of explanation and illustration.

### Examples 1-6

The formulas listed in Table 1 comprise various chewing gum formulas including encapsulated particles. The encapsulated particles can be added to the other ingredients directly, or they may first be suspended in an aqueous medium.

TABLE 1
Wt. %

| | Example 1 | Example 2 | Example 3 | Example 4 | Example 5 | Example 6 |
|---|---|---|---|---|---|---|
| Sugar | 61.9 | 60.4 | 60.8 | 60.8 | 60.8 | 68.3 |
| Gum Base | 19.2 | 19.2 | 19.2 | 19.2 | 19.2 | 19.2 |
| Glycerin | 1.4 | 1.4 | 0.0 | 0.0 | 0.0 | 1.4 |
| Corn Syrup | 15.9 | 15.9 | 12.9 | 12.9 | 12.9 | — |
| Lecithin | 0.2 | 0.2 | 0.2 | 0.2 | 0.2 | 0.2 |
| Peppermint | 0.9 | 0.9 | 0.9 | 0.9 | 0.9 | 0.9 |
| Flavor | | | | | | |
| Encapsulated | 0.5 | 2.0 | 6.0 | 6.0 | 6.0 | 10.0 |
| particles | | | | | | |

### Examples 7-8

Using the following formulation of a sugar or sugar-free gum, a variety of encapsulated flavor samples can be evaluated:

TABLE 2
Wt. %

| | Example 7 | Example 8 |
|---|---|---|
| | Sugar Free | Sugar |
| Sorbitol | 46.8 | — |
| Sugar | — | 52.7 |
| Mannitol | 8.0 | — |
| Gum Base | 25.5 | 20.0 |
| Glycerin | 8.5 | 1.4 |
| Corn Syrup | — | 12.0 |
| Lycasin brand | 6.8 | — |
| Hydrogenated Starch | — | — |
| Hydrolyzates | — | — |
| Dextrose Monohydrate | — | 10.0 |
| Peppermint Flavor | 1.4 | 0.9 |
| Encapsulated particles | 3.0 | 3.0 |

### Examples 9-13

Any type of encapsulated particle may be added to the following types of chewing gum formulas:

TABLE 3
Wt. %

| | | Example 10 | Example 11 | Example 12 | Example 13 |
|---|---|---|---|---|---|
| | Example 9 | Sugar With | Sugarless | Sugarless | Sugarless No |
| | Sugar | Sorbitol | With Water | With Lycasin | Water |
| Gum Base | 19.2 | 19.2 | 25.5 | 25.5 | 25.5 |
| Sugar | 55.0 | 53.0 | — | — | — |
| Sorbitol | — | 2.0 | 52.8 | 48.5 | 51.3 |
| Mannitol | — | — | 8.0 | 8.0 | 12.0 |
| Corn Syrup | 13.1 | 13.1 | — | — | — |
| Lycasin/Sorbitol | — | — | 9.5^{(a)} | 6.8^{(b)} | — |
| Liquid | | | | | |
| Glycerin | 1.4 | 1.4 | 1.5 | 8.5 | 8.5 |
| Lecithin | — | — | 0.2 | 0.2 | 0.2 |
| Dextrose | 9.9 | 9.9 | — | — | — |
| Monohydrate | | | | | |
| Level of | 1.4 | 1.4 | 2.5 | 2.5 | 2.5 |
| Encapsulated | | | | | |
| Particles | | | | | |

^{(a)}liquid sorbitol (70% sorbitol, 30% water)
^{(b)}hydrogenated starch hydrolyzate syrup

### Examples 14-20

Encapsulated particles can also be used in sugar type gum formulations containing other sugars, such as in the following formulations in Examples 14-20:

TABLE 4
Wt. %

| | Example | Example | Example | Example | Example | Example | Example |
|---|---|---|---|---|---|---|---|
| | 14 | 15 | 16 | 17 | 18 | 19 | 20 |
| Gum Base | 19.2 | 19.2 | 19.2 | 19.2 | 19.2 | 19.2 | 19.2 |
| Sugar | 58.5 | 48.5 | 48.5 | 47.5 | 46.5 | 46.4 | 48.5 |
| Glycerin | 1.4 | 1.4 | 1.4 | 1.4 | 1.4 | 1.4 | 1.4 |
| Corn Syrup | 19.0 | 23.0 | 19.0 | 19.0 | 23.0 | 16.0 | 16.0 |
| Dextrose | — | — | 5.0 | — | — | — | — |
| Lactose | — | — | — | — | 5.0 | — | — |
| Fructose | — | — | 5.0 | — | — | — | — |
| Invert Sugar | — | — | — | 10.0 | — | — | — |
| Maltose | — | — | — | — | — | 10.0 | — |
| Palatinose | — | — | — | — | — | — | 10.0 |
| Corn Syrup | — | 5.0 | — | — | — | — | — |
| Solids | | | | | | | |
| Peppermint | 0.9 | 0.9 | 0.9 | 0.9 | 0.9 | 0.9 | 0.9 |
| Flavor | | | | | | | |
| Level of | 1.0 | 2.0 | 1.0 | 2.0 | 4.0 | 4.0 | 4.0 |
| Encapsulated | | | | | | | |
| Particles | | | | | | | |

These formulations may also contain sugar alcohols such as sorbitol, mannitol, xylitol, lactitol, maltitol, hydrogenated isomaltulose, and Lycasin or combinations thereof.

Sugarless type gum formulations with encapsulated particles can also be made using various sugar alcohols, such as the following formulations in Examples 21-29:

TABLE 5
Wt. %

| | Example | Example | Example | Example | Example | Example | Example | Example | Example |
|---|---|---|---|---|---|---|---|---|---|
| | 21 | 22 | 23 | 24 | 25 | 26 | 27 | 28 | 29 |
| Base | 25.5 | 25.5 | 25.5 | 25.5 | 25.5 | 25.5 | 25.5 | 25.5 | 25.5 |
| Sorbitol | 53.0 | 46.0 | 41.0 | 41.0 | 41.0 | 41.0 | 36.0 | 37.0 | 46.0 |
| Sorbitol | 17.0 | 14.0 | 6.0 | — | 5.0 | — | — | 6.0 | 18.0 |
| Lycasin | | | | | | | | | |
| Mannitol | — | 10/0 | 8.0 | 8.0 | 8.0 | 8.0 | 8.0 | 8.0 | 8.0 |
| Maltitol | — | — | — | 5.0 | — | — | 5.0 | 00 | 00 |
| Xylitol | — | — | 15.0 | 10.0 | — | — | 5.0 | 15.0 | — |
| Lactitol | — | — | — | — | 10.0 | — | — | — | — |
| Hydrogenated | — | — | — | — | — | 15.0 | 10.0 | — | — |
| Isomaltulose | | | | | | | | | |
| Glycerin | 2.0 | 2.0 | 2.0 | 8.0 | 8.0 | 8.0 | 8.0 | 6.0 | — |
| Flavor | 1.5 | 1.5 | 1.5 | 1.5 | 1.5 | 1.5 | 1.5 | 1.5 | 0.5 |
| Level of | 1.0 | 1.0 | 1.0 | 1.0 | 1.0 | 1.0 | 1.0 | 1.0 | 2.0 |
| Encapsulated | | | | | | | | | |
| Particles | | | | | | | | | |

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

What is claimed is:

1. A method of producing a chewing gum product, comprising
a) providing a core comprising a first flavoring agent;
b) coating the core with a first layer to form a first coated product, wherein the first layer is selected from a hydrophobic layer and a hydrophilic layer;
c) coating the first coated product with a second layer comprising a second flavoring agent to form an encapsulated particle, wherein the second layer is selected from a hydrophobic layer and a hydrophilic layer;
d) mixing the encapsulated particle with gum base to form a chewing gum composition; and
e) forming the chewing gum composition into a chewing gum product.

2. The method of claim 1 wherein the core is coated with the first layer in a fluid bed coater.

3. The method of claim 1 wherein the first coated product is coated with the second layer in a fluid bed coater.

4. The method of claim 1 wherein the first layer is a hydrophobic layer.

5. The method of claim 1 wherein the second layer is a hydrophilic layer.

6. The method of claim 1 wherein the chewing gum product provides a first wave of flavor from the second flavoring agent followed by a second wave of flavor from the first flavoring agent.

7. The method of claim 1 wherein the first flavoring agent is selected from the group consisting of flavors, sweeteners, physiological cooling agents, and mixtures thereof.

8. The method of claim 1 wherein the second flavoring agent is selected from the group consisting of flavors, sweeteners, physiological cooling agents, and mixtures thereof.

9. The method of claim 1 wherein the core is prepared by spray drying.

10. The method of claim 1 wherein the core is between about 10 microns and about 100 microns in diameter.

11. The method of claim 1 wherein the core is between about 0.2 microns and about 10 microns in diameter

12. The method of claim 1 wherein the encapsulated particle is between about 100 microns and about 300 microns in diameter

13. The method of claim 1 wherein the first layer comprises a material selected from the group consisting of zein, wax, and polyvinyl acetate.

14. The method of claim 1 wherein the second layer comprises a material selected from the group consisting of acacia gum, gelatin, and shellac.

15. A chewing gum product comprising a plurality of encapsulated particles, at least some of the encapsulated particles comprising:
a) a core comprising a first flavoring agent;
b) a first layer surrounding the core and comprising a hydrophobic material; and
c) a second layer surrounding the first layer and comprising a second flavoring agent;
wherein the chewing gum, when chewed, provides a first wave of flavor from the second flavoring agent followed by a second wave of flavor from the first flavoring agent.

16. The chewing gum product of claim 15 wherein the second layer comprises a hydrophilic material.

17. The method of claim 15 wherein the first layer comprises a material selected from the group consisting of zein, wax, and polyvinyl acetate.

18. The method of claim 15 wherein the second layer comprises a material selected from the group consisting of acacia gum, gelatin, and shellac.

19. A chewing gum product comprising a plurality of a first type of encapsulated particles and a plurality of a second type of encapsulated particles, wherein the first type of encapsulated particle comprises:
a core comprising a first flavoring agent; and
a layer surrounding the core and comprising a first hydrophobic material; and wherein the second type of encapsulated particle comprises:
a core comprising a second flavoring agent; and
a layer surrounding the core and comprising a second hydrophobic material;
wherein the first and second hydrophobic materials provide different release times for the first flavoring agent and the second flavoring agent.

20. The chewing gum product of claim 19 wherein the first and second hydrophobic materials are the same.

21. The chewing gum product of claim 19 wherein the layers in the first and second hydrophobic types of encapsulated particles are of different thicknesses.
